(19) United States
(12) Patent Application Publication
(10) Pub. No.: US 2016/0084102 A1
(43) Pub. Date: Mar. 24, 2016

(54) ABRADABLE SEAL AND METHOD FOR FORMING AN ABRADABLE SEAL

(71) Applicant: GENERAL ELECTRIC COMPANY, Schenectady, NY (US)

(72) Inventors: Surinder Singh PABLA, Greer, SC (US); Luc Stephane LEBLANC, Clifton Park, NY (US); Donald Earl FLOYD, Greenville, SC (US)

(21) Appl. No.: 14/489,686

(22) Filed: Sep. 18, 2014

(51) Int. Cl. F01D 11/12; F16J 15/16

(52) U.S. Cl. CPC F01D 11/122; F16J 15/16; F05D 2230/90; F05D 2300/611; F05D 2300/173; F05D 2300/2118; F05D 2300/608; F05D 2250/181

(57) ABSTRACT

An abradable seal having a metallic substrate and a multi-layered ceramic coating on the metallic substrate. The multi-layered ceramic coating includes a base layer deposited on the metallic substrate, an abradable layer overlaying the first layer, and an abrading layer overlaying the second layer. The abrading layer is formed of an abrading material. A turbine system and a method for forming an abradable seal are also disclosed.

### FIELD OF THE INVENTION

The present invention is directed to a method of fabricating abradable seals. More specifically, the present invention is directed to a method for forming an abradable seal having abradable and abrading properties.

### BACKGROUND OF THE INVENTION

Many systems, such as those in gas turbines, are subjected to thermally, mechanically and chemically hostile environments. For example, in the compressor portion of a gas turbine, atmospheric air is compressed to 10-25 times atmospheric pressure, and adiabatically heated to about 800° F. to about 1250° F. in the process. This heated and compressed air is directed into a combustor, where it is mixed with fuel. The fuel is ignited, and the combustion process heats the gases to very high temperatures, in excess of about 3000° F. These hot gases pass through the turbine, where airfoils fixed to rotating turbine disks extract energy to drive the fan and compressor of the turbine, and the exhaust system, where the gases provide sufficient energy to rotate a generator rotor to produce electricity. Tight seals and precisely directed flow of the hot gases provide operational efficiency. To achieve such tight seals in turbine seals and precisely directed flow can be difficult to manufacture and expensive.

During operation, the turbine casing (shroud) remains fixed relative to the rotating blades. Typically, the highest efficiencies can be achieved by maintaining a minimum threshold clearance between the shroud and the blade tips to thereby prevent unwanted “leakage” of a hot gas over tip of the buckets. Increased clearances lead to leakage problems and cause significant decreases in overall efficiency of the gas turbine engine.

Attempts have been made to minimize the clearance gap to improve efficiency while avoiding excessive wear on the turbine blade tips. For instance, some conventional turbine engines include thermal barrier coatings (TBCs) on the ring seal segments. Ceramic materials are typically utilized as TBC materials because of their high temperature capability and low thermal conductivity. Known abradable coating systems utilize TBCs that are designed such that a portion of the coating will abrade away when contacted by a turbine blade to prevent damage to the turbine blade. The TBCs also insulate the underlying turbine components from the hot gases present during operation, which may be more than 2000 degrees Fahrenheit. The TBCs maintain the temperature of the underlying turbine component at a significantly lower temperature.

The need to maintain adequate clearance without significant loss of efficiency is made more difficult by the fact that the clearance between a blade tip and the shroud may be non-uniform over the entire circumference of the shroud. Non-uniformity is caused by a number of factors including machining tolerances during machining, stack-up tolerances, and non-uniform expansion due to varying thermal mass and thermal response. Such non-uniformity results in variation in the length of the turbine blade and its impingement on the abradable coating, resulting in non-uniform abrasion of the abradable coating. Known systems minimize the gap and design for the non-uniformity of the blade tips, while avoiding damage to the turbine blade tips.

Another common problem with abradable coatings is that the coatings degrade via sintering after extended exposure to turbine engine operating temperatures. Sintering of the abradable coating significantly reduces the abradable coating's ability to shear when contacted by tips of turbine blades. For high temperature operation, yttria stabilized zirconia (YSZ) destabilizes and the erosion and abradable properties of the coating are reduced.

Thus, the need exists for an abradable coating that addresses non-uniform blade length, provides sufficient insulation for the underlying substrate, allows abrasion of the abradable coating under operational conditions, remains adherent to the substrate and provides longer-term reliability and improved operating efficiency. An abradable seal and a method for forming an abradable seal that do not suffer from one or more of the above drawbacks would be desirable in the art.

### BRIEF DESCRIPTION OF THE INVENTION

In one embodiment, an abradable seal having a metallic substrate and a multi-layered ceramic coating on the metallic substrate. The multi-layered ceramic coating includes a base layer deposited on the metallic substrate, an abradable layer overlaying the first layer, and an abrading layer overlaying the second layer. The abrading layer is formed of an abrading material.

In another embodiment, a turbine system having a plurality of rotating components and an abradable seal. The abradable seal includes a metallic substrate and a multi-layered ceramic coating on the metallic substrate. The multi-layered ceramic coating includes a base layer deposited on the bond coat, an abradable layer overlaying the first layer, and an abrading layer overlaying the second layer. The abrading layer is formed of an abrading material. The rotating components and abradable seal are arranged and disposed to contact the abradable seal with the rotating component.

In another embodiment, a method for forming an abradable seal. The method includes depositing a multi-layered ceramic coating on the metallic substrate. The multi-layered ceramic coating includes a base layer deposited on the bond coat, an abradable layer overlaying the first layer and an abrading layer overlaying the second layer. The abrading layer is formed of an abrading material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary turbine arrangement having an abradable seal, according to an embodiment of the disclosure.

FIG. 2 shows an exemplary seal arrangement having multiple layers positioned on a substrate, according to an embodiment of the disclosure.

FIG. 3 illustrates the abrading of the rotating component provided by the abradable seal, according to an embodiment of the disclosure.

FIG. 4 shows erosion data showing comparative erosion rates for various YSZ stabilized layers.

FIG. 5 shows erosion data showing comparative erosion rates for various YSZ stabilized layers.

Wherever possible, the same reference numbers will be used throughout the drawings to represent the same parts.

### DETAILED DESCRIPTION OF THE INVENTION

Provided is an abradable seal and process for fabricating an abradable seal having abradable and abrading properties. Embodiments of the present disclosure, in comparison to similar concepts failing to include one or more of the features disclosed herein, provide a tight seal with turbine systems including systems having non-uniform blade length. In addition, the abradable seal, according to the disclosure, maintains insulative properties, allows for abrasion of the abradable coating, and remains adherent to the substrate during operational conditions of the turbine system, providing longer-term reliability and improved operating efficiency of the gas turbine.

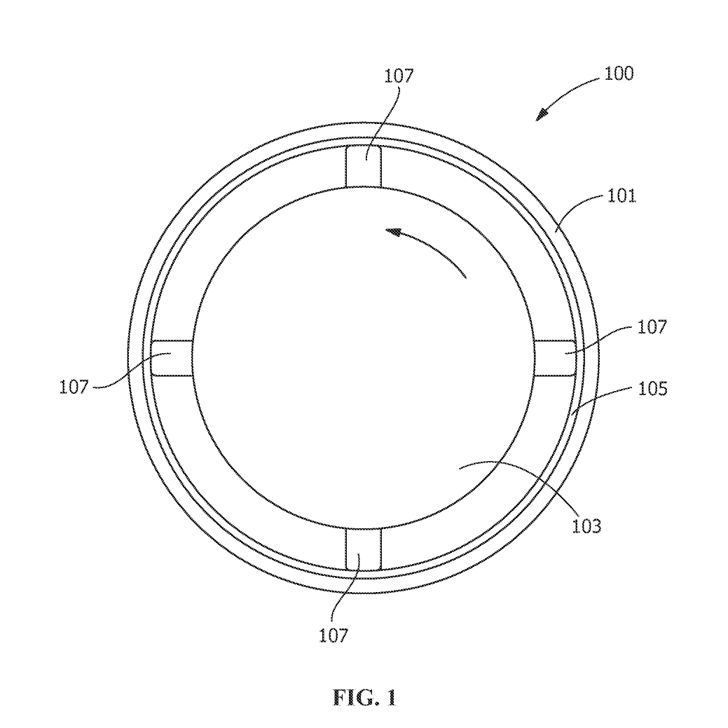

FIG. 1 shows a schematic sectional view of a turbine section of a gas turbine system 100 viewed in the direction of a center axis of rotation. The gas turbine system 100 includes a stationary component 101, such as a turbine shroud, surrounding a rotor 103. The stationary component 101 is any suitable component that remains in a fixed position with respect to a rotating component.

An abradable seal 105 is disposed on the stationary component 101. Rotating components 107 are attached to the rotor 103. The rotating components 107 are suitable turbine buckets or turbine blades. The terms “blade” and “bucket” are used interchangeably herein. The rotating components 107 contact or are in near contact with the abradable seal 105 during rotation of the rotor 103.

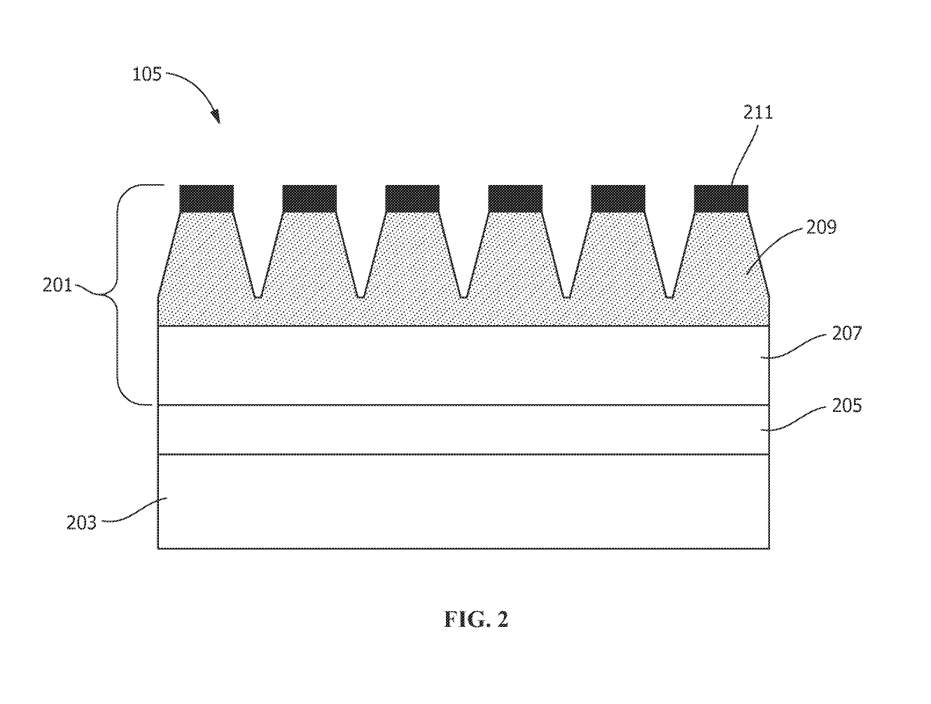

FIG. 2 shows a section schematic view of an abradable seal 105, according to an embodiment. The abradable seal 105 is made up of a multi-layered ceramic coating 201 on a metallic substrate 203. As used herein, the term “metallic” is intended to encompass metals, alloys, composite metals, intermetallic materials, or any combination thereof. In one embodiment, the substrate 203 includes or is stainless steel. In another embodiment, the substrate 203 includes or is a nickel-based alloy. Other suitable alloys include, but are not limited to, cobalt-based alloys, chromium-based alloys, carbon steel, and combinations thereof. Suitable metals include, but are not limited to, titanium, aluminum, and combinations thereof. In one embodiment, metallic substrate 203 is disposed at an interior surface of the stationary component 101, the interior surface being the surface facing the rotor 103. However, the metallic substrate 203 is not so limited and includes other suitable surfaces. In the embodiment shown in FIG. 2, the abradable seal 105 includes a bond coating 205 between the multi-layered ceramic coating 201 and the metallic substrate. The bond coating 205 includes, for example, MCrAlY, where M is Nickel (Ni), Cobalt (Co), Iron (Fe) or some combination thereof, or inter-metallic of Beta-NiAl. The bond coating 205 may be formed from materials such as, but not limited to, powders such as CoCrAlY, NiCrAlY, CoNiCrAlY, and rhenium containing versions and other appropriate materials.

Overlaying the bond coat 205, the multi-layered ceramic coating 201 includes a base layer 207. The base layer 207 includes a thermal barrier coating material. The thermal barrier coating material includes, for example, barium strontium aluminosilicate or zirconia, partially stabilized with yttria. In one embodiment, the base layer 207 contains less than about 10 wt % yttria, or about 6 wt % to about 8 wt % yttria or about 7 wt % to about 8 wt % yttria. While yttria is disclosed as a suitable stabilizer, other stabilizers may likewise be utilized, such as erbia, gadolinia, neodymia, ytterbia, lanthana, and/or dysprosia. The partial stabilization of the YSZ with 6 to 8 wt % yttria (e.g., less than about 10 wt % YSZ) results in a more adherent and spallation-resistant layer when subjected to high temperature thermal cycling than YSZ TBC containing greater amounts of yttria. Furthermore, partially stabilized YSZ (e.g., less than about 10 wt % YSZ) is more erosion-resistant than fully stabilized YSZ (e.g., about 20 wt % YSZ). The base layer 207 provides an adherent coating that is resistant to sintering and spallation. In one embodiment, the base layer 207 includes a microstructure referred to herein as dense vertical microcracks (DVC). Thermal-sprayed DVC TBCs are disclosed, for example, in U.S. Pat. Nos. 5,073,433; 5,520,516; 5,830,586; 5,897,921; 5,989,343 and 6,047,539, for which each are hereby incorporated by reference in their entirety. Suitable thicknesses for the base layer include less than about 75 mils, from about 1 mils to about 75 mils or from about 5 mils to about 50 mils.

Also shown in FIG. 2, the multi-layered ceramic coating 201 includes an abradable layer 209 overlaying the base layer 207. The abradable layer 209 includes a ceramic thermal barrier coating material and has hardness sufficiently low to permit erosion and/or abrasion of the abradable layer 209 when contacted with rotating components 107. Similar to the base layer 207, the thermal barrier coating material of the abradable layer 209 includes, for example, barium strontium aluminosilicate or zirconia, either partially or fully stabilized with yttria, magnesia, calcia, or other stabilizers. In one embodiment the abradable layer 209 includes yttria as stabilizer and contains at least 15 wt % yttria and up to about 22 wt % yttria, or about 18% to about 20% yttria. In one embodiment the abradable layer 209 includes Yb₄Zr₃O₁₂. Other stabilizers may likewise be utilized, such as erbia, gadolinia, neodymia, ytterbia, lanthana, and/or dysprosia. In one embodiment, the abradable layer 209 comprises yttria stabilized zirconia (YSZ) or Yb₄Zr₃O₁₂ having dense vertical microcracks. Suitable thicknesses for the abrading layer 211 include from about 25 mils to about 75 mils, from about 40 mils to about 60 mils or about 50 mils. In addition, the abradable layer 209 is temperature resistant and retains the properties of abradability and thermal conductivity at gas turbine operational conditions. The fully stabilized YSZ (e.g., the zirconia comprising about 20 wt % yttria) provides a low thermal conductivity material, for example, offering 20-30% or 25-30% or about 30% lower thermal conductivities with respect to partially stabilized YSZ (e.g., YSZ with about 8 wt % yttria) as well as greater abradability when contacted with the rotating components 107. In one embodiment, the abradable layer 209 includes a DVC microstructure. By “abradable” and “abradability”, as utilized herein, it is meant that the material has the property of abrading or eroding to form a rub path when contacted with rotating components 107, with little or no damage to the rotating components.

In one embodiment, the abradable layer 209 is deposited into a geometric pattern. The geometric pattern is arranged to provide sealing and abrasion properties. By “geometric pattern”, it is meant that the abradable layer 209 is deposited with raised or protruding portions from the underlying layer forming a pattern that is repeated and visible as viewed from above. The geometric pattern may include patterns such as, but not limited to, diamond, ridge, hexagon, ellipse, circle, triangle, rectangle, or other suitable geometric patterns. In one embodiment, the raised or protruding portions of the geometric pattern extend above the underlying layer for a distance of equal to or less than about 0.065 inches or equal to or less than about 0.035 inches or equal to or less than about 0.015 inches.

The multi-layered ceramic coating includes an abrading layer 211 overlaying the abradable layer 209. The abrading layer 211 includes a thermal barrier coating material. In one embodiment, the abrading layer 211 has sufficient hardness to abrade the rotating components that come into contact with the abrading layer 211. By “abrading”, as utilized herein, it is meant that the material has the property of eroding or wearing rotating components 107 when contacted with the rotating components 107. Similar to the base layer 207, the thermal barrier coating material of the abrading layer 211 includes, for example, barium strontium aluminosilicate or zirconia, partially stabilized with yttria. In one embodiment, the abrading layer 211 contains less than about 10 wt % yttria, or about 7 wt % to about 8 wt % yttria. While yttria is disclosed as a suitable stabilizer, other stabilizers may likewise be utilized, such as erbia, gadolinia, neodymia, ytterbia, lanthana, and/or dysprosia. The abrading layer 211 is configured to minimize the gap between the rotating components 107 and the stationary component 101 and selectively abrading the rotating components that impinge on the layer due to non-uniformity in length, particularly while the turbine components are in different states of expansion, such as during a warm restart. The amount and rate of wear will depend upon the amount of non-uniformity of the rotating components 107. The thickness of the abrading coating is sufficient thickness to providing abrading properties and allow for erosion away to expose the abradable layer 209. Suitable thicknesses for the abrading layer 211 include less than 10 mils, from about 1 mil to about 10 mils or from about 1 mil to about 5 mils. In one embodiment, the abrading layer 211 includes a DVC microstructure. In one embodiment, the abrading layer 211 includes a porous structure. In one embodiment, the abrading layer 211 includes the same material as the base layer 207. In another embodiment, the abrading layer 211 includes material that is different than the base layer 207.

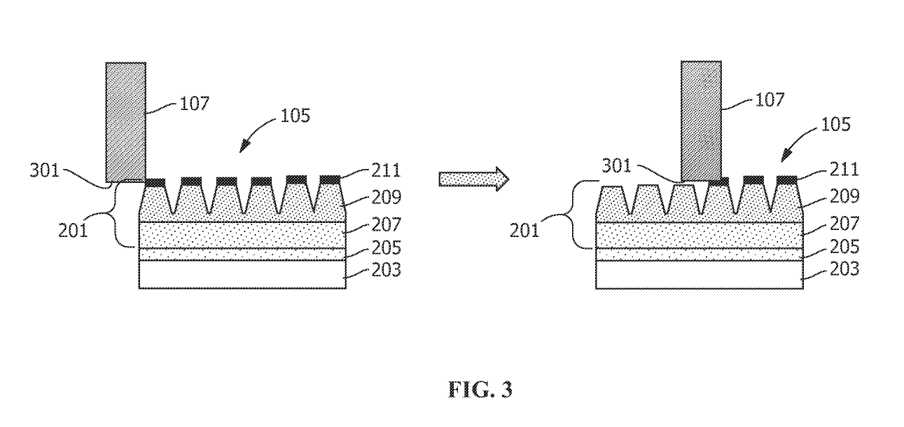

FIG. 3 shows a method of utilizing the abradable seal 105, such as at startup of the gas turbine. As shown in FIG. 3, the rotating component 107 includes a tip region 301 that contacts the abradable seal 105 at the abrading layer 211. As the rotating component 107 contacts the abrading layer 211, the tip region 301 of the rotating component 107 is abraded. In addition, the abrading layer 211 is eroded away from the abradable seal 105. Upon further rotation, the rotating components 107 further contact the abradable layer 209 and abrade a seal path within the abradable layer 209. The abrading of the tip region 301 alters the length of the blade such that the blade length becomes more uniform. Greater uniformity of blade length results in a small or no gap between the rotating component 107 and the abradable seal 105.

Deposition of the base layer 207, the abradable layer 209 and the abrading layer 211 may be provided by any suitable deposition process known for depositing TBC materials. Suitable processes include deposition by thermal spraying (e.g., air plasma spraying (APS) and high-velocity oxygen flame (HVOF) spraying) and physical vapor deposition (PVD) techniques such as electron beam physical vapor deposition (EBPVD). One particularly suitable process for depositing the base layer 207, the abradable layer 209 and the abrading layer 211 is that disclosed in U.S. Pat. No. 5,073,433. As a result of this process each of the base layer 207, abradable layer 209 and the abrading layer 211 contain vertical microcracks, preferably at least twenty-five cracks per linear inch of surface, with at least some of the microcracks extending completely through the outer layer to its interface with the underlying layer.

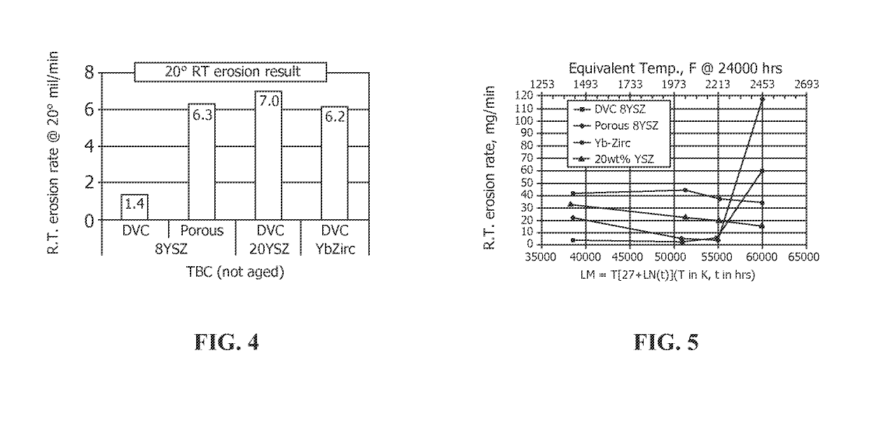

FIGS. 4 and 5 shows erosion data showing comparative erosion rates for various YSZ stabilized layers. As shown in FIG. 4, the erosion of the 8 wt % YSZ (8YSZ) having dense vertical microcracks (DVC) is substantially lower than the 20 wt % yttria stabilized zirconia and the Yb₄Zr₃O₁₂ (YbZirc). FIG. 5 shows that the erosion rates at equivalent temperatures wherein the 8YSZ is begins to substantially erode when exposed to higher temperatures compared to the 20YSZ and Yb₄Zr₃O₁₂. As shown, the combination of the 8YSZ and 20YSZ (or Yb₄Zr₃O₁₂) in the arrangement according to the present disclosure provides the of abradability (i.e., erosion) in the abradable layer 209 as well as the desirable abrading properties of the abrading layer 211 with high temperature stability.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An abradable seal comprising:
a metallic substrate; and
a multi-layered ceramic coating on the metallic substrate, said multi-layered ceramic coating comprising:
a base layer deposited on the metallic substrate,
an abradable layer overlaying the first layer, and
an abrading layer overlaying the second layer,
wherein said abrading layer is formed of an abrading material.

2. The abradable seal of claim 1, further comprising a bond coat between the substrate and the multi-layered ceramic coating.

3. The abradable seal of claim 2, wherein the bond coat is an MCrAlX overlay coating.

4. The abradable seal of claim 1, said base layer comprising a ceramic layer of material selected from the group consisting of zirconia stabilized with ceria, zirconia stabilized with magnesia, zirconia stabilized with calcia, zirconia stabilized with yttria and mixtures thereof.

5. The abradable seal of claim 1, wherein the base layer comprises yttria stabilized zirconia (YSZ) comprising about 7 to about 8 wt % yttria.

6. The abradable seal of claim 5, wherein the base layer comprises a microstructure having dense vertical microcracks.

7. The abradable seal of claim 1, wherein the abradable layer comprises yttria stabilized zirconia (YSZ) about 18 to about 20 wt % yttria.

8. The abradable seal of claim 7, wherein the abradable layer comprises a microstructure having dense vertical microcracks.

9. The abradable seal of claim 1, wherein the abradable layer comprises Yb₄Zr₃O₁₂.

10. The abradable seal of claim 9, wherein the abradable layer comprises a microstructure having dense vertical microcracks.

11. The abradable seal of claim 1, wherein the abradable layer is arranged into a geometric pattern.

12. The abradable seal of claim 9, wherein the geometric pattern is a diamond pattern.

13. The abradable seal of claim 9, wherein the geometric pattern is a ridged pattern.

14. The abradable seal of claim 1, wherein the abrading material is yttria stabilized zirconia (YSZ) comprising about 7 to about 8 wt % yttria.

15. The abradable seal of claim 1, wherein the base layer and the abrading layer are formed of the same material.

16. A turbine system comprising:
a plurality of rotating components;
an abradable seal comprising:
a metallic substrate; and
a multi-layered ceramic coating on the metallic substrate, said multi-layered ceramic coating comprising:
a base layer deposited on the bond coat,
an abradable layer overlaying the first layer, and
an abrading layer overlaying the second layer,
wherein said abrading layer is formed of an abrading material;
wherein the rotating components and abradable seal are arranged and disposed to contact the abradable seal with the rotating component.

17. A method for forming an abradable seal comprising:
depositing a multi-layered ceramic coating on a metallic substrate, said multi-layered ceramic coating comprising:
a base layer deposited on the bond coat,
an abradable layer overlaying the first layer, and
an abrading layer overlaying the second layer,
wherein said abrading layer is formed of an abrading material.

18. The method of claim 17, further comprising contacting the multi-layered ceramic coating with a rotating component.

19. The method of claim 17, wherein the component is a turbine blade.

20. The method of claim 17, wherein the depositing includes patterning in the abradable layer into a geometric pattern.
